(19) United States
(12) Patent Application Publication
(10) Pub. No.: US 2025/0383891 A1
(43) Pub. Date: Dec. 18, 2025

(54) OPERATING SYSTEM INTELLIGENT CONTEXT-AWARE COPY-PASTE

(71) Applicant: INTERNATIONAL BUSINESS MACHINES CORPORATION, ARMONK, NY (US)

(72) Inventors: Jessica Nahulan, Markham (CA); Jeremy R. Fox, Georgetown, TX (US); Carolina Garcia Delgado, Zapopan (MX); Tiberiu Suto, Franklin, NY (US)

(21) Appl. No.: 18/743,302

(22) Filed: Jun. 14, 2024

(51) Int. Cl. G06F 9/451; G06F 40/166

(52) U.S. Cl. CPC G06F 9/451; G06F 40/166

(57) ABSTRACT

An embodiment for an intelligent context-aware copy-paste in an operating system (OS) is provided. The embodiment may include receiving data relating to a current task of a user within an OS. The embodiment may also include inputting one or more copied items to a clipboard inventory. The embodiment may further include identifying a context of the one or more copied items and a context of the current task of the user at a paste command location. The embodiment may also include computing a match confidence score for the one or more copied items. The embodiment may further include pasting a copied item having a highest match confidence score to the paste command location. The embodiment may also include based on determining the user accepts the pasting, adding metadata relating to the one or more copied items to a knowledge corpus.

### BACKGROUND

The present invention relates generally to the field of computing, and more particularly to a system for an intelligent context-aware copy-paste in an operating system (OS).

The traditional OS copy-paste function enables users to highlight text or images and then replicate them later on in a document or chat window. Without the traditional OS copy-paste function, the users would have to manually retype desired portions of text, which can be a time-consuming and frustrating process. The convenience of the traditional OS copy-paste function allows for a seamless user experience and makes the function one of the most popular in any OS.

### SUMMARY

According to one embodiment, a method, computer system, and computer program product for an intelligent context-aware copy-paste in an operating system (OS) is provided. The method, computer system, and computer program product may include receiving data relating to a current task of a user within an OS. The method, computer system, and computer program product may also include inputting one or more copied items to a clipboard inventory based on the data. The method, computer system, and computer program product may further include identifying a context of the one or more copied items and a context of the current task of the user at a paste command location. The method, computer system, and computer program product may also include computing a match confidence score for the one or more copied items based on the context of the one or more copied items and the context of the current task of the user. The method, computer system, and computer program product may further include pasting a copied item, from the one or more copied items, having a highest match confidence score to the paste command location. The method, computer system, and computer program product may also include based on determining the user accepts the pasting, adding metadata relating to the one or more copied items to a knowledge corpus.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for an intelligent context-aware copy-paste in an operating system (OS) in a context aware copy-paste process according to at least one embodiment.

FIG. 3 is an exemplary diagram depicting an interaction between solution components of the process in FIG. 2 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for an intelligent context-aware copy-paste in an operating system (OS). The following described exemplary embodiments provide a system, method, and program product to, among other things, identify a context of one or more copied items and a context of a current task of a user at a paste command location and, accordingly, paste a copied item, from the one or more copied items, having a highest match confidence score to the paste command location. Therefore, the present embodiment has the capacity to improve computers by enhancing the traditional OS copy-paste functionality.

As previously described, the traditional OS copy-paste function enables users to highlight text or images and then replicate them later on in a document or chat window. Without the traditional OS copy-paste function, the users would have to manually retype desired portions of text, which can be a time-consuming and frustrating process. The convenience of the traditional OS copy-paste function allows for a seamless user experience and makes the function one of the most popular in any OS. The traditional OS copy-paste function lacks contextual understanding, efficient management of the clipboard inventory, and personalized recommendations based on user preferences and usage. This problem is typically addressed by providing a user with an ability to switch to an application into which the user was intending to paste the content. However, merely switching applications fails to support a multi-copy inventory to which an intelligent paste is used to retrieve the correct context-aware paste content from the clipboard.

It may, therefore, be imperative to provide a method, system, and computer program product for an advanced AI-powered clipboard manager at the OS level. Thus, embodiments of the present invention may provide advantages including, but not limited to, enhancing the traditional OS copy-paste functionality, efficiently managing clipboard inventory, and improving user productivity. The present invention does not require that all advantages need to be incorporated into every embodiment of the invention.

According to at least one embodiment, when working in an OS window, data relating to a current task of a user within an OS may be received in order to input one or more copied items to a clipboard inventory based on the data. Upon inputting the one or more copied items to the clipboard inventory, a context of the one or more copied items and a context of the current task of the user at a paste command location may be identified so that a match confidence score may be computed for the one or more copied items based on the context of the one or more copied items and the context of the current task of the user. Then, a copied item, from the one or more copied items, having a highest match confidence score may be pasted to the paste command location such that it may be determined whether the user accepts the pasting. According to at least one embodiment, based on determining the user accepts the pasting, metadata relating to the one or more copied items may be added to a knowledge corpus.

According to at least one other embodiment, based on determining the user does not accept the pasting, at least one other copied item in the clipboard inventory that is manually selected by the user may be pasted to the paste command location. Upon pasting the at least one other copied item, the metadata relating to the one or more copied items may be added to the knowledge corpus.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to identify a context of one or more copied items and a context of a current task of a user at a paste command location and, accordingly, paste a copied item, from the one or more copied items, having a highest match confidence score to the paste command location.

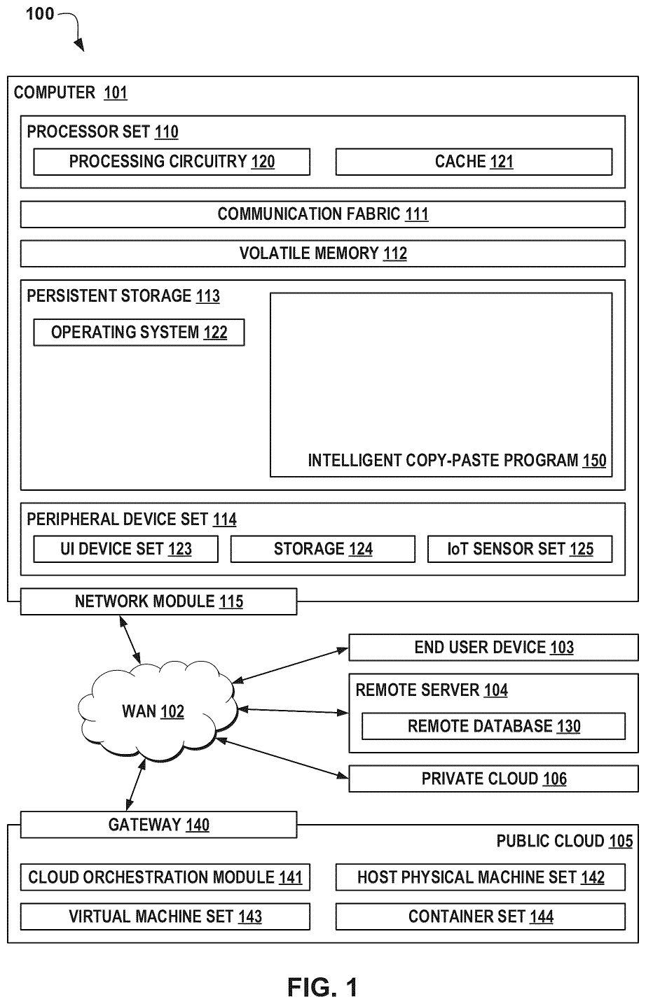

Referring to FIG. 1, an exemplary computing environment 100 is depicted, according to at least one embodiment. Computing environment 100 contains an example of an environment for the execution of at least some of the computer code involved in performing the inventive methods, such as an intelligent copy-paste program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

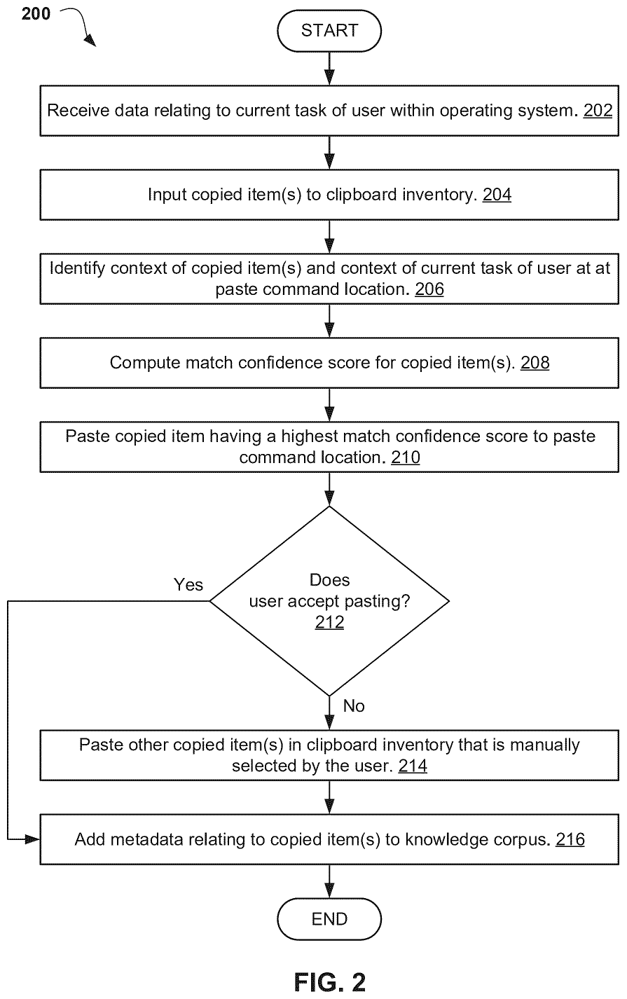

According to the present embodiment, the intelligent copy-paste program 150 may be a program capable of receiving data relating to a current task of a user within an OS, identifying a context of one or more copied items and a context of a current task of the user at a paste command location, pasting a copied item having a highest match confidence score to the paste command location, enhancing the traditional OS copy-paste functionality, efficiently managing clipboard inventory, and improving user productivity. Furthermore, notwithstanding depiction in computer 101, the intelligent copy-paste program 150 may be stored in and/or executed by, individually or in any combination, end user device 103, remote server 104, public cloud 105, and private cloud 106. The intelligent copy-paste method is explained in further detail below with respect to FIG. 2. It may be appreciated that the examples described below are not intended to be limiting, and that in embodiments of the present invention the parameters used in the examples may be different.

Referring now to FIG. 2, an operational flowchart for an intelligent context-aware copy-paste in an OS in a context aware copy-paste process 200 is depicted according to at least one embodiment. At 202, the intelligent copy-paste program 150 receives the data relating to the current task of the user within the OS. The data relating to the activity may include, but it not limited to, a type of application that is open, a pre-defined number of days to store copied items in a clipboard, and/or user preferences and interactions (e.g., the frequency of specific items being copied and pasted). For example, the type of application open may be a word processing application and/or a chat window. In another example, the pre-defined number of days to store copied items in the clipboard may be 7 days. In yet another example, the user preferences may include likes, dislikes, preferred types of content, and scheduling data.

The data relating to the activity may also include, but is not limited to, IoT collected data such as scheduled upcoming tasks, current location of the user, current news information near the location of the user, and/or current concerns of the user. An online calendar may be integrated with the intelligent copy-paste program 150 to obtain the schedule of the user. For example, the user may be scheduled to work on a report at 2:00 p.m.

The data relating to the activity is collected in real-time and historically. The historical data may be input into and retrieved from the knowledge corpus and/or the database, such as remote database 130. In this manner, the real-time data becomes the historical data upon being input into the knowledge corpus and/or remote database 130.

Then, at 204, the intelligent copy-paste program 150 inputs the one or more copied items to the clipboard inventory. The one or more copied items are input based on the data. The clipboard may be integrated with the intelligent copy-paste program 150, which may operate in the background of the OS and be available when needed by the user. Any copied items may be stored in accordance with the pre-defined number of days described above with respect to step 202. Additionally, these copied items may be stores across multiple sessions and across different OSs.

According to at least one embodiment, the user may manually copy the one or more copied items to the clipboard inventory. The user may manually copy the one or more copied items to the clipboard inventory by utilizing the OS copy function. For example, many OSs feature a shortcut where the user can highlight text or an image and hit “Ctrl+C” on their keyboard. Continuing the example, the user may copy a citation from a research paper, an image from a chart, and/or a URL.

According to at least one other embodiment, inputting the one or more copied items to the clipboard inventory may include autonomously copying at least one item to the clipboard inventory. The intelligent copy-paste program 150 may autonomously copy the at least one item to the clipboard inventory based on the IoT collected data, such as scheduled upcoming tasks, current location of the user, current news information near the location of the user, and/or current concerns of the user. A machine learning (ML) model may be trained with the IoT collected data as well as the data described above with respect to step 202 to predict user behavior and preferences as time progresses. Since the dataset used to train the ML model can be large, a random forest algorithm may be used to combine multiple decision trees to make accurate predictions of copies to be performed autonomously. For example, when the user is scheduled to attend an upcoming team meeting in an advertising agency, the intelligent copy-paste program 150 may autonomously copy advertising content (e.g., a chart depicting ad sales) as the user navigates in an open window.

According to at least one further embodiment, the one or more copied items may be inputted to the clipboard inventory based on one or more user prompts. The one or more prompts may be a mention of content by the user. For example, the user may mention a cooking article they found 6 days ago. Continuing the example, based on this mention, the content of the cooking article may be added to the clipboard inventory.

According to at least one other embodiment, the one or more copied items in the clipboard inventory may be color coded in accordance with the time stored of each copied item. For example, copied items in red may be removed soon (e.g., less than 24 hours) from the clipboard inventory. Copied items in yellow may be removed later than copied items in red (e.g., 24-48 hours) from the clipboard inventory. Copied items in green may be items just added to the clipboard inventory and have the longest storage time (e.g. up to a week).

Next, at 206, the intelligent copy-paste program 150 identifies the context of the one or more copied items and the context of the current task of the user at the paste command location. In order to achieve a comprehensive contextual understanding, a natural language processing (NLP) service may be integrated with the intelligent copy-paste program 150.

According to at least one embodiment, the NLP may be utilized to identify the context of the one or more copied items in the clipboard inventory. In particular, the NLP may analyze contextual features related to the one or more copied items including, but not limited to, who, what, where, when, why, and how.

For example, the “who” may be the specific user that copied the item to the clipboard inventory. The “what” may be the type of content copied (e.g., an image, text, and/or a URL). The “where” may be the location where the copy took place. The “when” may be a time at which the copy took place, which may include a timestamp. The “why” may be a reason for copying the item (e.g., the user is working on a presentation). Finally, the “how” may be the means by which the item is copied (e.g., manually, autonomously, or by prompt). This information may be added to the knowledge corpus, described in further detail below with respect to step 216.

According to at least one other embodiment, the NLP may be utilized to identify the context of the current task of the user at the paste command location. The paste command location may be a location in a document and/or chat window where the user intends to paste at least one of the one or more copied items in the clipboard inventory. The paste command location may be triggered by the user. For example, many OSs feature a shortcut where the user can place their cursor and hit “Ctrl+V” on their keyboard. In another example, the paste command location may be identified by a verbal command of the user. Continuing the example, the user may say, “I have the link here.” In this example, the context may be that the user intends to paste a link to a website. It may be appreciated that in embodiments of the present invention, the context of the current task of the user may be identified when the user intends to initiate a paste, since the context of the user may change continuously during a session. For example, the context of the user may change when the user is multitasking and working in multiple open windows at once. Continuing the example, where the user is working in a chat window, and then switches to a document and hits paste, the intelligent copy-paste program 150 may only consider the context within the document and may not consider the context within the chat window.

Then, at 208, the intelligent copy-paste program 150 computes the match confidence score for the one or more copied items. The match confidence score is computed based on the context of the one or more copied items and the context of the current task of the user. The context of the one or more copied items and the context of the current task of the user may be compared to determine the similarity between the contexts. Based on how similar the contexts are (e.g., the relevance of the one or more copied items to the current task of the user), the match confidence score may be computed for the one or more copied items.

According to at least one embodiment, when multiple copied items are relevant to the current task of the user, the match confidence score may be computed for each copied item. For example, when more than one copied item in the clipboard inventory have a match probability of over 70%, the match confidence score may be computed. The trained ML model may compute the match confidence score based on the similarity between the contexts. A higher match confidence score may indicate a higher relevance of the copied item.

For example, there may be three copied items in the clipboard inventory. The three copied items may include a citation from a research paper, an image from a chart, and a URL. While working on a report, the user may reference a diagram and then hit paste. In this example, the ML model may compute a match confidence score of 100 for the image from the chart, a match confidence score of 90 for the URL, and a match confidence score of 80 for the citation from the research paper.

According to at least one other embodiment, in addition to the contexts, the ML model may compute the match confidence score for the one or more copied items based on the one or more preferences of the user and the one or more prompts received from the user.

Continuing the example described above, the user may paste the URL with a greater frequency when working on the report than either of the image from the chart or the citation from the research paper. In this example, the ML model, using the preferences of the user, may compute a match confidence score of 100 for the URL, a match confidence score of 95 for the image from the chart, and a match confidence score of 80 for the citation from the research paper.

In another example, the user may be working in a chat window. The three copied items may include a citation from a research paper, an image from a chart, and a URL. While working giving a presentation in the chat window, the user may say, “I have the citation right here.” In this example, the ML model, using the one or more prompts received from the user, may compute a match confidence score of 100 for the citation from the research paper, a match confidence score of 90 for the image from the chart, and a match confidence score of 80 for the URL.

Next, at 210, the intelligent copy-paste program 150 pastes the copied item, from the one or more copied items, having the highest match confidence score to the paste command location.

For example, there may be three copied items in the clipboard inventory. The three copied items may include the citation from a research paper, the image from a chart, and the URL. While working on a report, the user may reference a diagram and then hit paste. When the ML model computes a match confidence score of 100 for the image from the chart, a match confidence score of 90 for the URL, and a match confidence score of 80 for the citation from the research paper, the image from the chart may be the copied item that is pasted to the paste command location.

According to at least one other embodiment, where the ML model computes the match confidence score for the one or more copied items based on the one or more preferences of the user, pasting the copied item having the highest match confidence score to the paste command location may include pasting the copied item based on the one or more preferences of the user.

Continuing the example described above, the user may paste the URL with a greater frequency when working on the report than either of the image from the chart or the citation from the research paper. In this example, when the ML model computes, using the preferences of the user, a match confidence score of 100 for the URL, a match confidence score of 95 for the image from the chart, and a match confidence score of 80 for the citation from the research paper, the URL may be the copied item that is pasted to the paste command location.

According to at least one further embodiment, where the ML model computes the match confidence score for the one or more copied items based on the one or more prompts received from the user, pasting the copied item having the highest match confidence score to the paste command location may include pasting the copied item based on the one or more prompts received from the user.

In another example, the user may be working in a chat window. The three copied items may include a citation from a research paper, an image from a chart, and a URL. While working giving a presentation in the chat window, the user may say, “I have the citation right here.” In this example, when the ML model computes, using the one or more prompts received from the user, a match confidence score of 100 for the citation from the research paper, a match confidence score of 90 for the image from the chart, and a match confidence score of 80 for the URL, the citation from the research paper may be the copied item that is pasted to the paste command location.

According to at least one other embodiment, the copied item having the highest match confidence score may be determined from an upcoming activity of the user. For example, when the user is scheduled to attend an upcoming team meeting in an advertising agency focused on selling video games, then during the meeting the intelligent copy-paste program 150 may paste an article about video games to the paste command location when the paste command is initiated by the user.

Then, at 212, the intelligent copy-paste program 150 determines whether the user accepts the pasting.

According to at least one embodiment, the determination may be made based on keyboard input received from the user. For example, when the copied item that is pasted is not the item the user intended to paste, the user may highlight the pasted text or image and hit the “Delete” or “Backspace” button.

According to at least one other embodiment, the determination may be made based on verbal input received from the user. For example, when the copied item that is pasted is not the item the user intended to paste, the user may say, “Please remove paste” or simply “No.”

According to at least one further embodiment, the determination may be made based on one or more gestures received from the user. For example, when the copied item that is pasted is not the item the user intended to paste, the user may shake their head no and/or display a “thumbs-down” to an integrated camera.

Based on determining the user does not accept the pasting (step 212, “No” branch), the context aware copy-paste process 200 proceeds to step 214 to paste the at least one other copied item in the clipboard inventory that is manually selected by the user to the paste command location. Based on determining the user accepts the pasting (step 212, “Yes” branch), the context aware copy-paste process 200 proceeds to step 216 to add the metadata relating to the one or more copied items to the knowledge corpus.

Next, at 214, the intelligent copy-paste program 150 pastes the at least one other copied item in the clipboard inventory that is manually selected by the user to the paste command location. When the user does not accept the pasting, the pasting of the copied item having the highest match confidence score may be removed.

According to at least one embodiment, pasting the at least one other copied item in the clipboard inventory may include displaying a ranked list to the user containing a top three highest matching copied items.

For example, there may be five copied items in the clipboard inventory. Upon discarding the copied item having the highest match confidence score due to being rejected by the user, the next top three highest matching copied items may include the citation from a research paper, the image from a chart, and the URL. The match confidence score for the image from the chart may be 90, the match confidence score for the URL may be 80, and the match confidence score for the citation from the research paper may be 70. In this example, the ranked list may display the image from the chart, the URL, and the citation from the research paper to the user in descending order from highest to lowest match confidence score.

According to at least one other embodiment, the at least one other copied item may be identified based on an interaction of the user with the ranked list. For example, the user may tap or click on the number adjacent to the copied item in the ranked list. Continuing the example, the user may tap or click on “#2” adjacent to the second copied item in the ranked list.

According to at least one further embodiment, the at least one other copied item may be identified by the user navigating through the clipboard inventory. For example, when the user does not accept the initial pasting and does not select any copied item in the ranked list, the entire clipboard inventory may be displayed to the user to select the desired item to paste.

Then, at 216, the intelligent copy-paste program 150 adds the metadata relating to the one or more copied items to the knowledge corpus. The metadata may be utilized by the intelligent copy-paste program 150 to assist in prioritizing the one or more copied items for pasting. The metadata may include, but is not limited to, a timestamp indicating when the one or more copied items were inputted to the clipboard inventory, a text summary describing one or more context-related properties of the one or more copied items, a link to the one or more copied items, one or more relevance weight factors, and/or related copied items in the sequence. For example, the timestamp may indicate a copied item was copied at 12:03 p.m. on May 16^{th}. In another example, the text summary may include a brief description of a copied image or text along with descriptive text relating to a location from which the copied item was obtained. In yet another example, the one or more relevance weight factors may include weights applied to the factors that influence the computation of the match confidence score. Continuing the example, preferences of the user may have a weight relevance factor of 70, user activities and tasks may have a relevance weight factor of 20, an upcoming scheduled activity of the user may have a relevance weight factor of 90, and a location of the user may have a relevance weight factor of 40.

According to at least one embodiment, the knowledge corpus may also include both positive and negative feedback data from the user. Positive feedback may occur when the user confirms that the correct copied item was pasted (e.g., the user accepts the pasting as described above with respect to step 212). Negative feedback may occur when an incorrect paste has occurred (e.g., the user does not accept the pasting as described above with respect to step 212). The ML model may be trained with both the positive and negative feedback data to continuously update parameters of the ML model such that more accurate pasting predictions may be made in the future.

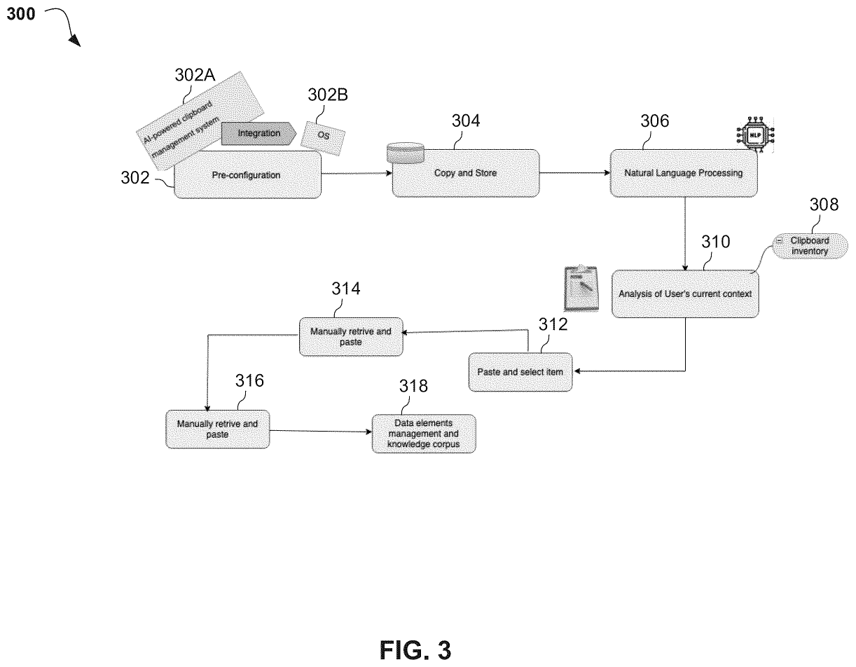

Referring now to FIG. 3, an exemplary diagram 300 depicting an interaction between solution components of the process in FIG. 2 is shown according to at least one embodiment. In the diagram 300, a pre-configuration module 302 may integrate an AI clipboard management system 302A to the OS 302B. The pre-configuration module 302 may configure settings set by the user, such as a time duration to store the one or more copied items. A copy and store module 304 may input the one or more copied items to the clipboard inventory 308 either autonomously or based on a copy command by the user. An NLP module 306 may provide text summary descriptions to the one or more copied items in the clipboard inventory 308. The clipboard inventory 308 may be fed to a context analysis module 310 to identify the context of the one or more copied items as well as analyze the context of the current task of the user. A pasting module 312 may select and paste a copied item having the highest match confidence score to the paste command location. Based on determining the user does not accept the pasting, a first retrieve and paste module 314 may display a ranked list to the user containing a top three highest matching copied items and paste the at least one other copied item that is manually selected by the user based on an interaction of the user with the ranked list. Based on determining the user does not select a copied item from the ranked list, a second retrieve and paste module 316 may display all of the copied items in the clipboard inventory 308 for the user to navigate through the clipboard inventory 308 to make a manual selection of the at least one other copied item. Finally, a data element management module 318 may add the metadata to the knowledge corpus to assist in prioritizing the one or more copied items for pasting.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of an intelligent context-aware copy-paste in an operating system, the method comprising:
receiving data relating to a current task of a user within an operating system;
inputting one or more copied items to a clipboard inventory based on the data;
identifying a context of the one or more copied items and a context of the current task of the user at a paste command location;
computing a match confidence score for the one or more copied items based on the context of the one or more copied items and the context of the current task of the user;
pasting a copied item, from the one or more copied items, having a highest match confidence score to the paste command location;
determining whether the user accepts the pasting; and
based on determining the user accepts the pasting:
adding metadata relating to the one or more copied items to a knowledge corpus.

2. The computer-based method of claim 1, further comprising:
based on determining the user does not accept the pasting:
pasting at least one other copied item in the clipboard inventory that is manually selected by the user to the paste command location; and
adding the metadata relating to the one or more copied items to the knowledge corpus.

3. The computer-based method of claim 2, wherein pasting the at least one other copied item in the clipboard inventory further comprises:
displaying a ranked list to the user containing a top three highest matching copied items; and
identifying the at least one other copied item based on an interaction of the user with the ranked list.

4. The computer-based method of claim 1, wherein inputting the one or more copied items to the clipboard inventory further comprises:
autonomously copying at least one item to the clipboard inventory based on an upcoming activity of the user.

5. The computer-based method of claim 1, wherein pasting the copied item having the highest match confidence score to the paste command location further comprises:
pasting the copied item based on one or more prompts received from the user.

6. The computer-based method of claim 1, wherein pasting the copied item having the highest match confidence score to the paste command location further comprises:
pasting the copied item based on one or more preferences of the user.

7. The computer-based method of claim 1, wherein the metadata added to the knowledge corpus includes a timestamp indicating when the one or more copied items were inputted to the clipboard inventory and a text summary describing one or more context-related properties of the one or more copied items.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving data relating to a current task of a user within an operating system;
inputting one or more copied items to a clipboard inventory based on the data;
identifying a context of the one or more copied items and a context of the current task of the user at a paste command location;
computing a match confidence score for the one or more copied items based on the context of the one or more copied items and the context of the current task of the user;
pasting a copied item, from the one or more copied items, having a highest match confidence score to the paste command location;
determining whether the user accepts the pasting; and
based on determining the user accepts the pasting:
adding metadata relating to the one or more copied items to a knowledge corpus.

9. The computer system of claim 8, the method further comprising:
based on determining the user does not accept the pasting:
pasting at least one other copied item in the clipboard inventory that is manually selected by the user to the paste command location; and
adding the metadata relating to the one or more copied items to the knowledge corpus.

10. The computer system of claim 9, wherein pasting the at least one other copied item in the clipboard inventory further comprises:
displaying a ranked list to the user containing a top three highest matching copied items; and
identifying the at least one other copied item based on an interaction of the user with the ranked list.

11. The computer system of claim 8, wherein inputting the one or more copied items to the clipboard inventory further comprises:
autonomously copying at least one item to the clipboard inventory based on an upcoming activity of the user.

12. The computer system of claim 8, wherein pasting the copied item having the highest match confidence score to the paste command location further comprises:
pasting the copied item based on one or more prompts received from the user.

13. The computer system of claim 8, wherein pasting the copied item having the highest match confidence score to the paste command location further comprises:
pasting the copied item based on one or more preferences of the user.

14. The computer system of claim 8, wherein the metadata added to the knowledge corpus includes a timestamp indicating when the one or more copied items were inputted to the clipboard inventory and a text summary describing one or more context-related properties of the one or more copied items.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving data relating to a current task of a user within an operating system;
inputting one or more copied items to a clipboard inventory based on the data;
identifying a context of the one or more copied items and a context of the current task of the user at a paste command location;
computing a match confidence score for the one or more copied items based on the context of the one or more copied items and the context of the current task of the user;
pasting a copied item, from the one or more copied items, having a highest match confidence score to the paste command location;
determining whether the user accepts the pasting; and
based on determining the user accepts the pasting:
adding metadata relating to the one or more copied items to a knowledge corpus.

16. The computer program product of claim 15, the method further comprising:
based on determining the user does not accept the pasting:
pasting at least one other copied item in the clipboard inventory that is manually selected by the user to the paste command location; and
adding the metadata relating to the one or more copied items to the knowledge corpus.

17. The computer program product of claim 16, wherein pasting the at least one other copied item in the clipboard inventory further comprises:
displaying a ranked list to the user containing a top three highest matching copied items; and
identifying the at least one other copied item based on an interaction of the user with the ranked list.

18. The computer program product of claim 15, wherein inputting the one or more copied items to the clipboard inventory further comprises:
autonomously copying at least one item to the clipboard inventory based on an upcoming activity of the user.

19. The computer program product of claim 15, wherein pasting the copied item having the highest match confidence score to the paste command location further comprises:
pasting the copied item based on one or more prompts received from the user.

20. The computer program product of claim 15, wherein pasting the copied item having the highest match confidence score to the paste command location further comprises:
pasting the copied item based on one or more preferences of the user.
